(19) United States
(12) Patent Application Publication
(10) Pub. No.: US 2026/0281142 A1
(43) Pub. Date: Sep. 17, 2026

(54) AGENTIC AI-POWERED CYBERSECURITY FRAMEWORK FOR ZERO-DAY VULNERABILITY DETECTION AND MITIGATION

(71) Applicant: Samsung Electronics Co., Ltd., Suwon-si (KR)

(72) Inventors: Yin Yang, Fremont, CA (US); Zhaoxu Zhang, Sunnyvale, CA (US); Kan Zha, Fremont, CA (US); Sean McClelland, Orlando, FL (US)

(21) Appl. No.: 19/265,905

(22) Filed: Jul. 10, 2025

Related U.S. Application Data
(60) Provisional application No. 63/772,245, filed on Mar. 14, 2025.

(51) Int. Cl. H04L 9/40

(52) U.S. Cl. CPC H04L 63/1433

(57) ABSTRACT

A method includes receiving a security vulnerability report describing a security vulnerability in natural language and generating at least one executable symbolic rule based on the security vulnerability report using predefined executable symbolic rules templates. The at least one executable symbolic rule is generated using at least one LLM-based executable symbolic rules agent trained to generate executable symbolic rules. The method also includes executing the at least one executable symbolic rule on a database of devices that includes specifications of the devices to provide analysis information on which of the devices are affected by the security vulnerability and receiving the analysis information together with the report at an LLM-based recommender agent trained to recommend mitigation strategies. The method further includes recommending a mitigation strategy for the devices affected by the security vulnerability using the LLM-based recommender agent and providing the analysis information and the mitigation strategy to a web portal.

### CROSS-REFERENCE TO RELATED APPLICATION AND CLAIM OF PRIORITY

This application claims priority under 35 U.S.C. § 119(e) to U.S. Provisional Patent Application No 63/772,245 filed on Mar. 14, 2025, which is hereby incorporated by reference in its entirety.

### TECHNICAL FIELD

This disclosure relates generally to cybersecurity systems and processes. More specifically, this disclosure relates to an agentic artificial intelligence (AI)-powered cybersecurity framework for zero-day vulnerability detection and mitigation.

### BACKGROUND

In the ever-evolving landscape of technology, the importance of cybersecurity for mobile devices cannot be overstated. For the most widely used mobile operating systems globally, vulnerabilities have become a prime target for cyber threats. In the business realm, corporate employees have come to rely heavily on mobile devices as indispensable tools for daily work tasks. However, determining the vulnerability list affecting a device fleet is very challenging, since investigation and assessment of a vulnerability must often be manually performed on a per-vulnerability or a per-device model basis. Therefore, mobile device manufacturers may consider providing customers with accurate and timely vulnerability-to-device mapping, to prevent misreporting in the marketplace, to be a market requirement.

### SUMMARY

This disclosure relates to an agentic artificial intelligence (AI)-powered cybersecurity framework for zero-day vulnerability detection and mitigation.

In a first embodiment, a method includes receiving a security vulnerability report from an external source describing a security vulnerability in a natural language. The method also includes generating at least one executable symbolic rule based on the security vulnerability report using predefined executable symbolic rules templates, where the at least one executable symbolic rule is generated using at least one large language model (LLM)-based executable symbolic rules agent trained to generate executable symbolic rules based on security vulnerability reports. The method further includes executing the at least one executable symbolic rule on a database of devices that includes specifications of the devices to provide analysis information on which of the devices are affected by the security vulnerability. The method also includes receiving the analysis information together with the report at an LLM-based recommender agent trained to recommend mitigation strategies. In addition, the method includes recommending a mitigation strategy for the devices affected by the security vulnerability using the LLM-based recommender agent and providing the analysis information and the mitigation strategy to a web portal.

In a second embodiment, a system includes at least one communication interface and at least one processing device in communication with the at least one communication interface. The at least one processing device is configured to receive a security vulnerability report from an external source describing a security vulnerability in a natural language via the at least one communication interface. The at least one processing device is also configured to generate at least one executable symbolic rule based on the security vulnerability report using predefined executable symbolic rules templates, where the at least one executable symbolic rule is generated using at least one LLM-based executable symbolic rules agent trained to generate executable symbolic rules based on security vulnerability reports. The at least one processing device is further configured to execute the at least one executable symbolic rule on a database of devices that includes specifications of the devices to provide analysis information on which of the devices are affected by the security vulnerability. The at least one processing device is also configured to receive the analysis information together with the report at an LLM-based recommender agent trained to recommend mitigation strategies. In addition, the at least one processing device is configured to recommend a mitigation strategy for the devices affected by the security vulnerability using the LLM-based recommender agent and provide the analysis information and the mitigation strategy to a web portal.

In a third embodiment, a non-transitory machine readable medium contains instructions that when executed cause at least one processor of an electronic device to receive a security vulnerability report from an external source describing a security vulnerability in a natural language. The instructions when executed also cause the at least one processor to generate at least one executable symbolic rule based on the security vulnerability report using predefined executable symbolic rules templates, where the at least one executable symbolic rule is generated using at least one LLM-based executable symbolic rules agent trained to generate executable symbolic rules based on security vulnerability reports. The instructions when executed further cause at least one processor to execute the at least one executable symbolic rule on a database of devices that includes specifications of the devices to provide analysis information on which of the devices are affected by the security vulnerability. The instructions when executed also cause at least one processor to receive the analysis information together with the report at an LLM-based recommender agent trained to recommend mitigation strategies. In addition, the instructions when executed cause at least one processor to recommend a mitigation strategy for the devices affected by the security vulnerability using the LLM-based recommender agent and provide the analysis information and the mitigation strategy to a web portal.

Any single one or any combination of the following features may be used with the first, second, or third embodiment. The at least one executable symbolic rule may be generated by processing the report with the predefined executable symbolic rules templates using an LLM-based extract agent trained to infer initial executable symbolic rules from security vulnerability reports and evaluating the initial executable symbolic rules using an LLM-based critic agent trained to evaluate executable symbolic rules and obtain validation that the initial executable symbolic rules contain machine-acceptable components. The LLM-based critic agent may provide feedback regarding the initial executable symbolic rules to the LLM-based extract agent, and the LLM-based extract agent and the LLM-based critic agent may iteratively improve the initial executable symbolic rules. One or both of the LLM-based extract agent or the LLM-based critic agent may be updated during training based on expert feedback information from an external source. The LLM-based critic agent may provide the feedback regarding the initial executable symbolic rules to the LLM-based extract agent based on grammar of the initial executable symbolic rules, validation that the initial executable symbolic rules contain machine-acceptable components, and chain-of-thought reasoning tables of different combinations of multi-components in the initial executable symbolic rules. The mitigation strategy may be recommended by providing the LLM-based recommender agent with descriptive information for the security vulnerability, and the descriptive information may include at least one of: a Common Vulnerability Scoring System (CVSS) score, an identification of affected devices, an identification of affected vendors, a problem type, or a reference solution link. The LLM-based recommender agent may be used to generate feature-level mitigation strategies other than patches or operating system (OS) updates based on the analysis information and the descriptive information. The at least one executable symbolic rule may include at least one logical operator.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have”, “may have”, “include”, or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B”, “at least one of A and B”, and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for”, “having the capacity to”, “designed to”, “adapted to”, “made to”, or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a”, “an”, and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism”, “module”, “device”, “unit”, “component”, “element”, “member”, “apparatus”, “machine”, “system”, “processor”, or “controller”, within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration that may be employed for agentic artificial intelligence (AI)-based cybersecurity zero-day vulnerability detection and mitigation in accordance with this disclosure;

FIG. 2 illustrates an example process of agentic AI-based cybersecurity zero-day vulnerability detection and mitigation in accordance with this disclosure;

FIGS. 3A through 3C illustrate an example workflow for agentic AI-based cybersecurity zero-day vulnerability detection and mitigation in accordance with this disclosure;

FIGS. 4A through 4C illustrate example aspects of extracting vulnerable components within the workflow of FIGS. 3A through 3C in accordance with this disclosure; and

FIGS. 5A through 5C illustrate an example overview of adaptive expert feedback within the workflow of FIGS. 3A through 3C in accordance with this disclosure.

### DETAILED DESCRIPTION

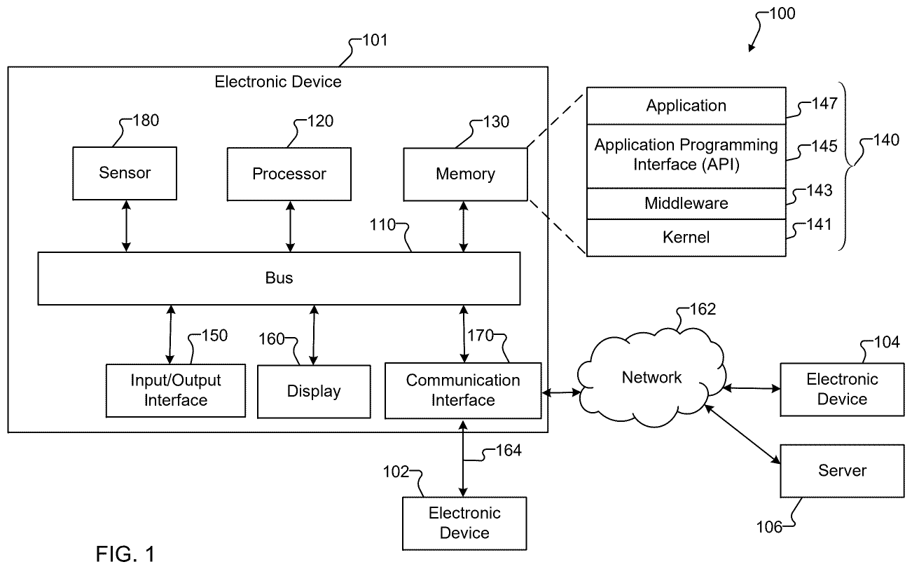

FIGS. 1 through 5C, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, in the ever-evolving landscape of technology, the importance of cybersecurity for mobile devices cannot be overstated. For the most widely used mobile operating systems globally, vulnerabilities have become a prime target for cyber threats. In the business realm, corporate employees have come to rely heavily on mobile devices as indispensable tools for daily work tasks. However, determining the vulnerability list affecting a device fleet is very challenging, since investigation and assessment of a vulnerability must often be manually performed on a per-vulnerability or a per-device model basis. Therefore, mobile device manufacturers may consider providing customers with accurate and timely vulnerability-to-device mapping, to prevent misreporting in the marketplace, to be a market requirement.

Mitigating the risk of vulnerability exploitation in mobile devices predominantly involves updating software through patches, which serves as a preventive measure. However, businesses can be hesitant to update operating systems or apply updates to devices due to potential business impacts. For example, business-critical apps developed by corporate entities may not support the latest operating system version. Therefore, customers may require mobile device manufacturers to identify workaround mitigation strategies to take feature-level actions (such as other than patch updates or operating system updates) as a form of risk management. Furthermore, workaround mitigation strategies to take feature-level actions other than patches or operating system updates are needed. For example, a vulnerability in a chipset may be exploited by a remote attacker to trigger remote code execution on targeted mobile devices. For customers unable to patch devices, turning off features such as Wi-Fi calling and voice-over-LTE (VoLTE) in the devices can mitigate such vulnerabilities.

The term “zero-day” (or “0-day”) refers to a security vulnerability that becomes publicly disclosed with the vendor(s) for the affected hardware or software/firmware having had no time (or “zero days”) to fix the problem. In these cases, there may be no immediate mitigation to prevent exploitation of the vulnerability. In security vulnerability lifecycle management, when a 0-day vulnerability is reported, business customers often have no way of knowing which of their devices in use across an organization may be affected by the vulnerability. Currently, official vulnerability disclosure for device models may occur months after initial public reporting. During this period, customers may not know that their device fleet is vulnerable, which increases both overall security risks and regulatory compliance burdens. Even when a vulnerability is published, business customers often are forced to guess whether the vulnerability affects their fleet, often erroneously assuming that all devices in the fleet are at-risk (even if the vulnerability only applies to specific device models). Accurately guessing which models are affected is complex, as vulnerabilities may affect only specific hardware subcomponents (such as modem chipsets). It is in a vendor's interest to provide customers with accurate and timely vulnerability-to-device mapping to prevent misreporting. Unfortunately, timely vulnerability-to-device mapping is challenging, since some vendors have a large pool of models and time is needed for engineers to manually review a vulnerability disclosure and determine which models are affected.

In addition, providing swift and effective mitigation strategies poses several challenges. First, actionable mitigations vary according to device specifics, as certain vulnerabilities target specific chipsets. Second, vulnerability reports are primarily written by software developers targeting code-level vulnerabilities, meaning corporate information technology (IT) administrators may be unclear on what feature-level actions should be taken, either in the interim until a security maintenance release (SMR) is available or if operating system (OS) updates cannot be installed due to conflict with critical business apps. Third, delivering effective mitigation lists often requires an in-depth understanding of cybersecurity domain knowledge. Finally, conventional rule-based approaches, though effective to some extent, are labor-intensive and challenging to sustain over the long term.

This disclosure provides various techniques for implementing an agentic artificial intelligence (AI)-powered cybersecurity framework for zero-day vulnerability detection and mitigation. Among other things, this framework can be used for vulnerability lifecycle management in the cybersecurity domain across fleets of corporate mobile devices. As described in more detail below, the framework supports a scalable way to analyze vulnerability disclosures, predict vulnerable components, and recommend mitigation strategies in an autonomous manner. When expert feedback is available, the framework can also fine-tune itself for improved performance.

The novel agentic AI-driven cybersecurity framework can use reasoning capabilities from LLMs. For example, a 0-day vulnerability report can be input to the framework, and the vulnerability report can be used to generate one or more executable symbolic rules using one or more LLM-based symbolic rules generation agents. The one or more executable symbolic rules can be executed in a security center backend to determine whether or not device models are affected by the vulnerability. For affected device models, an LLM-based cybersecurity expert mitigation strategy recommender can be triggered to provide a feature-level mitigation strategy. In some cases, the recommended mitigation may include a workaround for at-risk devices that are unable to conduct traditional security updates/patches. If cybersecurity expert feedback on the vulnerability is obtained, fine-tuning may be conducted to improve accuracy of the executable symbolic rules.

In some embodiments, vulnerably disclosures may include public vulnerability feeds, such as the MITRE Corporation Common Vulnerabilities and Exposures (CVE) and internal data sources. Also, in some embodiments, an agentic AI-based actor-critic self-correctness technique can be used to analyze data and generate vulnerability-to-component mappings in the form of executable symbolic rules. The executable symbolic rules may not be in any script format, which can help to avoid unexpected behaviors. Instead, the rules can be parameterized so that each rule can be executed in a security center (such as a cloud security service) backend (non-AI) in production. For affected device models, an agentic AI-based recommender can suggest mitigation strategies that can help put corporate customers back in regulatory compliance, even if managed devices are un-patchable. In addition, the executable symbolic rules-based agentic AI can improve accuracy over time, such as based on expert feedback with fine-turning.

FIG. 1 illustrates an example network configuration 100 that may be employed for agentic AI-based cybersecurity zero-day vulnerability detection and mitigation in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform various operations related to agentic AI-powered cybersecurity framework for zero-day vulnerability detection and mitigation.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to agentic AI-powered cybersecurity framework for zero-day vulnerability detection and mitigation. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, Wi-Fi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232 ), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network. The electronic device 101 can also be an augmented reality wearable device, such as eyeglasses, which include one or more imaging sensors, or a virtual reality (VR) or extended reality (XR) headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the server 106 may perform various operations related to agentic AI-powered cybersecurity framework for zero-day vulnerability detection and mitigation.

Although FIG. 1 illustrates one example of a network configuration 100 that may be employed for agentic AI-based cybersecurity zero-day vulnerability detection and mitigation, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

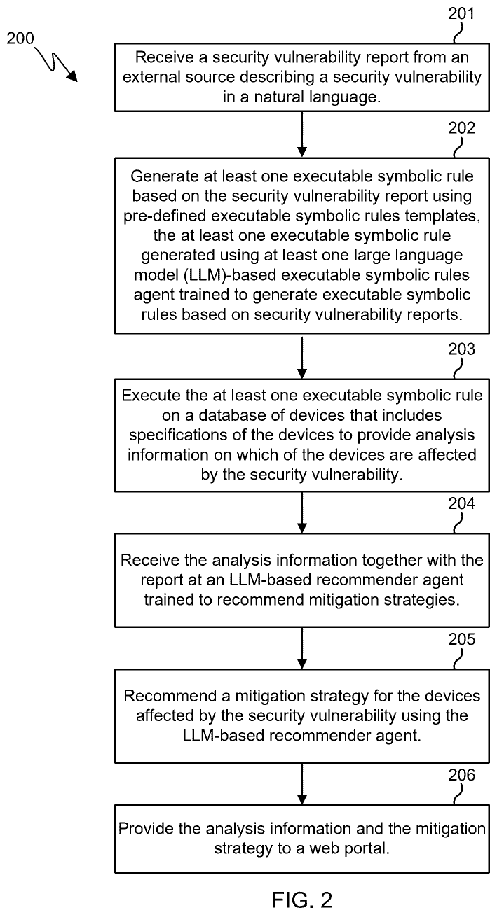

FIG. 2 illustrates an example process 200 of agentic AI-based cybersecurity zero-day vulnerability detection and mitigation in accordance with this disclosure. For ease of explanation, the process 200 of FIG. 2 is described as being performed using the server 106 in the network configuration 100 of FIG. 1. However, the process 200 may be performed using any other suitable device(s) (such as the electronic device 101) and in any other suitable system(s).

As shown in FIG. 2, the process 200 generally operates to identify impacted device components and applicable mitigation strategies for security vulnerabilities to enterprise device IT administrators or other users. The process 200 begins with receiving a security vulnerability report from an external source describing a security vulnerability in a natural language (step 201). The report may be, for example, a CVE report or a Security Vulnerability Exploit (SVE) report.

At least one executable symbolic rule is generated based on the security vulnerability report using predefined executable symbolic rules templates (step 202). At least one large language model (LLM)-based executable symbolic rules agent can be used, where the executable symbolic rules agent is trained to generate executable symbolic rules based on security vulnerability reports. In some cases, the at least one executable symbolic rule can include one or more logical operators (such as OR, AND, and/or NOT). In some embodiments, the at least one LLM-based executable symbolic rules agent includes (i) an LLM-based extract agent trained to infer initial executable symbolic rules from security vulnerability reports and (ii) an LLM-based critic agent trained to evaluate executable symbolic rules. In these embodiments, the LLM-based extract agent can generate one or more initial executable symbolic rules based on the report describing the security vulnerability, and the expression of those generated initial executable symbolic rules can be evaluated by the LLM-based critic agent, which can provide feedback to the LLM-based extract agent. For example, the LLM-based critic agent may check grammar of the initial executable symbolic rules, generate chain-of-thought reasoning tables of different combinations of multi-components in the expression of the initial executable symbolic rules, and validate that the initial executable symbolic rules contain machine-acceptable components. These checks enforce guardrails on the at least one LLM-based executable symbolic rules agent. In some cases, the LLM-based extract agent and the LLM-based critic agent can iteratively refine or improve executable symbolic rules to generate a final expression for the at least one executable symbolic rule.

The at least one executable symbolic rule is executed on a database of devices that includes specifications of the devices in order to provide analysis information on which of the devices are affected by the security vulnerability (step 203). In some embodiments, no AI may need to be used in executing the at least one executable symbolic rule on the database of devices. In some cases, the analysis information can include an identification of device models affected by the security vulnerability, possibly along with a reason (such as an identification of the component or components within the device model that are vulnerable) according to the report describing the security vulnerability.

The analysis information is received at an LLM-based recommender agent trained to recommend mitigation strategies (step 204). In some cases, the analysis information may optionally be received together with the report describing the security vulnerability. As noted above, the report may be a CVE report or an SVE report. The LLM-based recommender agent may also be provided with additional information describing the security vulnerability, such as a Common Vulnerability Scoring System (CVSS) score, one or more identifiers for one or more affected devices and/or one or more affected vendors, a description of one or more problem types, and/or a reference solution link.

A mitigation strategy for the devices affected by the security vulnerability is recommended using the LLM-based recommender agent (step 205). The mitigation strategy may include one or more feature-level actions, such as disabling near-field communications (NFC), universal serial bus (USB) ports, insecure Wi-Fi networks, or Bluetooth connections, which may be implemented by one or more enterprise device IT administrators. The analysis information and the mitigation strategy are provided to a web portal (step 206). In some cases, the web portal may be accessible to one or more enterprise customers.

Although FIG. 2 illustrates one example of a process 200 of agentic AI-based cybersecurity zero-day vulnerability detection and mitigation, various changes may be made to FIG. 2. For example, while shown as a series of steps, various steps in FIG. 2 could overlap, occur in parallel, occur in a different order, or occur any number of times (including zero times).

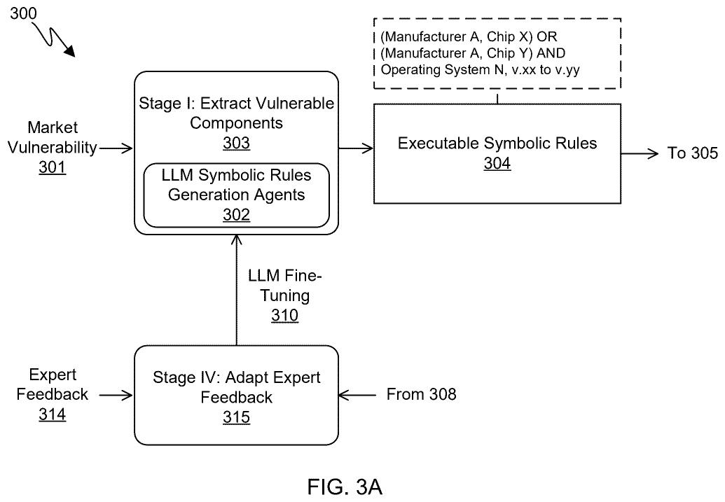

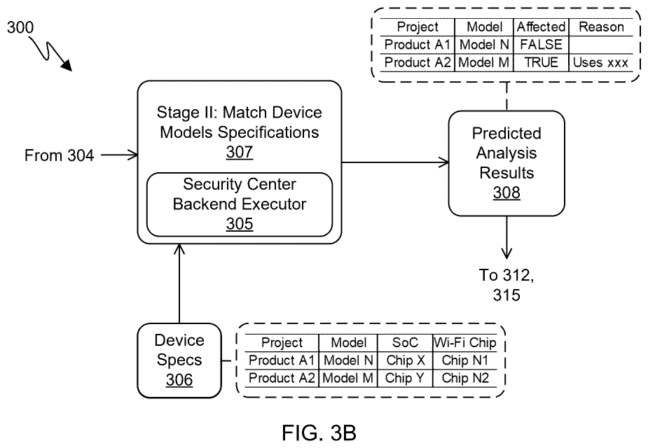

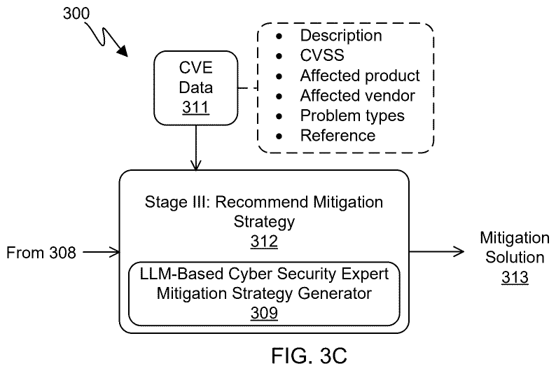

FIGS. 3A through 3C illustrate an example workflow 300 for agentic AI-based cybersecurity zero-day vulnerability detection and mitigation in accordance with this disclosure. For ease of explanation, the workflow 300 of FIGS. 3A through 3C is described as being implemented within the server 106 in the network configuration 100 of FIG. 1, potentially operating interactively with the electronic device 101 (for mitigation of vulnerabilities). However, the workflow 300 may be implemented using any other suitable device(s) (such as the electronic device 101) and in any other suitable system(s).

As shown in FIGS. 3A through 3C, the workflow 300 is described in four general stages, namely extracting vulnerable components 303 in FIG. 3A, matching device models specifications 307 in FIG. 3B, recommending mitigation strategies 309 in FIG. 3C, and adapting based on expert feedback 315 in FIG. 3A. However, a similar workflow could be logically viewed as fewer or more stages with the functionality described below for any stage combined or split. The workflow 300 provides at least an interim vulnerability and mitigation strategy (optionally with expert feedback), at least until patches or other security updates are available from a vendor.

As shown in FIG. 3A, the workflow 300 begins with receiving market vulnerability information 301 at LLM symbolic rules generation agents 302. The LLM symbolic rules generation agents 302 perform extraction of vulnerable components 303, producing executable symbolic rules 304. Examples of executable symbolic rules 304 are depicted in FIG. 3A and may take the form of “(Manufacturer A, Chip X) OR (Manufacturer A, Chip Y) AND Operating System N, v.xx to v.yy”.

In some cases, each of the LLM symbolic rules generation agents 302 may employ an LLM-based actor-critic self-correctness technique. That is, the LLM symbolic rules generation agents 302 may employ an extract agent that analyzes the market vulnerability information 301, which could be available from one or more public vulnerability feeds or internal data sources. The LLM symbolic rules generation agents 302 use predefined executable symbolic rules templates as in-context learning examples and output the executable symbolic rules 304. An LLM-based critic (ReAct) agent takes in the executable symbolic rules 304 and sends a request to a validator (such as one hosted on a server) through an application program interface (API) or other suitable mechanism. The validator may conduct a grammar check and machine-acceptable component check and return validation results to the critic agent through the API or other interface. The critic agent summarizes the validator returns into critic feedback and provides the feedback into the extract agent. The extract agent can improve the executable symbolic rules based on the critic agent feedback. After a few iterations, the extract agent and the critic agent can generate accurate and concise executable symbolic rules 304 without human evaluation in the feedback loop. In this manner, the validator can serve as a guardrail, preventing one or more LLM agents from hallucinating due to the stochastic nature of the validator. Assigning a single LLM with different roles by simply changing an input prompt without a guardrail could result in a product failure. In other embodiments, the LLM symbolic rules generation agents 302 may employ other forms of reinforcement learning, such as Q-learning in a deep Q network.

The generated executable symbolic rules 304 describe a vulnerability-to-component mapping and can be executed in a backend with an enterprise device specifications database or other database to verify the match for each component. An analysis result can thereby be generated, such as by identifying a device model (affected or not), a matched reason for an affected hardware or software/firmware component of the device model, and its version. The executable symbolic rules 304 need not be in any script format (such as Java, JavaScript, or Structured Query Language) and therefore avoid the risk of code injection attacks, which modify databases during backend execution processes.

As shown in FIG. 3B, the executable symbolic rules 304 are output to a security center backend executor 305. The security center backend executor 305 employs device specifications 306 to identify matching devices models 307 by applying the executable symbolic rules 304 to the device specifications 306. For simplicity, the example device specifications 306 illustrated in FIG. 3B include, for each product name and model, a system-on-a-chip (SoC) and a Wi-Fi chip. However, the devices specifications 306 may be more complicated and include identifications of many more hardware components, as well as software/firmware such as features enabled within some devices but not others.

The output of the security center backend executor 305 are predicted analysis results 308. A simplified example of predicted analysis results 308 is shown in FIG. 3B and includes, for each product name and model (and for a given identified vulnerability), whether the product/model is affected and (if so) a reason. The predicted analysis results 308 are output to an LLM-based cyber security expert mitigation strategy generator 309 depicted in FIG. 3C and are also made available for LLM fine-tuning 310 as shown in FIG. 3A.

As shown in FIG. 3C, the LLM-based cyber security expert mitigation strategy generator 309 receives CVE data 311. In this example, the CVE data 311 may include a description of the vulnerability, a CVSS metric, an identification of the affected product(s) (such as model(s), OS or software version(s), etc.), affected vendor(s) (if known), problem type(s), and reference information. The LLM-based cyber security expert mitigation strategy generator 309, which represents an LLM with cybersecurity expert as a role, is used to recommend mitigation strategies using few-shot prompting techniques.

For each vulnerability disclosure (such as from one or more public vulnerability feeds or internal data sources), the LLM-based cyber security expert mitigation strategy generator 309 may generate feature-level mitigation strategies (such as disable NFC, disable USB, disable insecure Wi-Fi network, disable Bluetooth, or unknown). When a patch or OS upgrade cannot be performed in corporate mobile devices, these mitigation strategies can disable operating system-specific functionality/settings. These feature-level mitigation strategies can be integrated with Mobile Device Management (MDM) to allow corporate IT administrators to remotely conduct the feature-level changes in a fleet-wide manner and can therefore serve as workarounds to mitigate of the risks of being exploited and keep these corporate devices in use. Accordingly, the LLM-based cyber security expert mitigation strategy generator 309 can generate mitigation strategy recommendation(s) 312, which can be output as mitigation solution(s) 313 made available to the customer(s) (such as the customer's IT administrators). As described above, the mitigation solution(s) 313 may include, for example, disabling the Wi-Fi chip until a patch becomes available. When software/firmware updates or patches are available, the mitigation solution(s) 313 may include installation of a software/firmware update or patch.

Referring back to FIG. 3A, the predicted analysis results 308 in FIG. 3B are made available, optionally together with expert feedback 314 regarding the predicted analysis results 308. This can form adaptive expert feedback 315, which can be used to perform LLM fine-tuning 310. Fine-tuning of the LLM symbolic rules generation agents 302 can be performed on that basis.

The agentic AI-based workflow 300 facilitates interim vulnerability assessment and mitigation strategy recommendation and may optionally incorporate expert feedback. This workflow 300 generates vulnerability-to-component mappings in the form of executable symbolic rules 304, which can (but need not necessarily) be generated using an LLM-based actor-critic self-correctness technique. In addition, the agentic AI workflow 300 can improve accuracy over time based on expert feedback via automatic fine-turning.

Although FIGS. 3A through 3C illustrate one example of a workflow 30 for agentic AI-based cybersecurity zero-day vulnerability detection and mitigation, various changes may be made to FIGS. 3A through 3C. For example, while depicted as being performed once for a given vulnerability, generation of the predicted analysis results 308 and LLM fine-tuning 310 may be performed iteratively for vulnerabilities until no further fine-tuning is suggested.

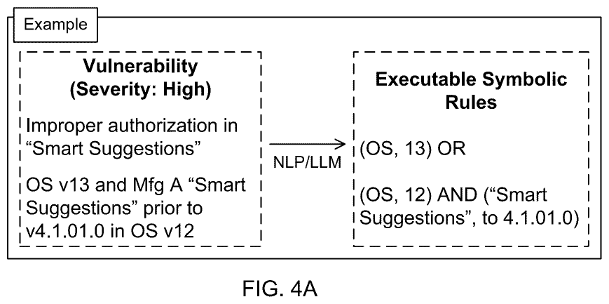

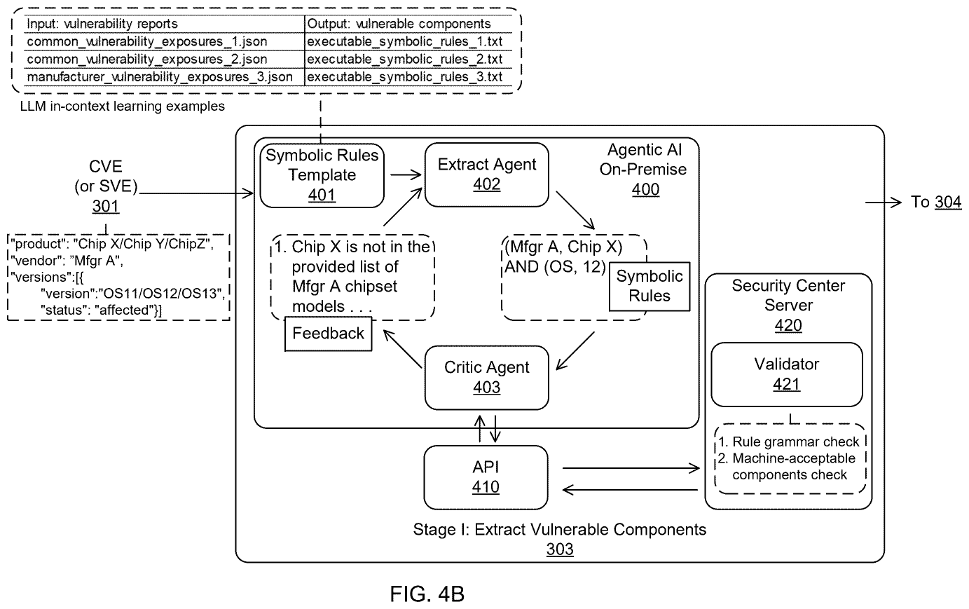

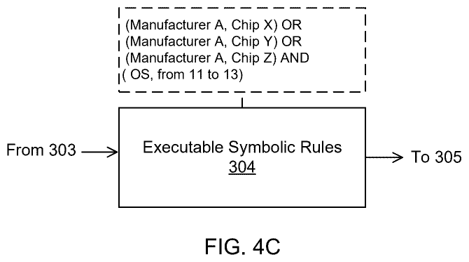

FIGS. 4A through 4C illustrate example aspects of extracting vulnerable components 303 within the workflow 300 of FIGS. 3A through 3C in accordance with this disclosure. In some embodiments, LLM-based guardrail-enforced extract agents and critic agents can be used to parse a vulnerability report into a multi-component expression. The input of the first stage of the workflow 300 (“extracting vulnerable components”) can include a vulnerability report, which is typically written in human natural language. The input data may or may not be structured (such as in a JavaScript Object Notation (JSON) format). The output of extracting vulnerable components 303 can include a vulnerability-to-component mapping in the form of one or more executable symbolic rules 304.

FIG. 4A illustrates an example of mapping a vulnerability report to executable symbolic rules. By normalizing the vulnerable components and the dependencies of those components from vulnerability reports, an easy-to-execute grammar results for the executable symbolic rules. The multi-component expressions of an executable symbolic rule may contain AND, OR, and/or NOT operations to represent conjunction relationships of vulnerable software and hardware components from the vulnerability report. For example, an executable symbolic rule may have the form “Component A OR Component B AND NOT Component C,” where each Component identifies at least vendor/product name and model/version. The individual component of each executable symbolic rule may include a device specification field name, such as the SoC vendor name, the product name of software or hardware on the device, and the chipset model or software version boundary. FIG. 4A illustrates components “(OS, 13) OR ((OS, 12) AND (Smart Suggestions, to 4.1.01.0)” from an example vulnerability report.

FIGS. 4B and 4C illustrate extracting vulnerable components 303 in greater detail. Generating executable symbolic rules 304 enables accurately assessing the impact of a vulnerability. In this example, extracting vulnerable components 303 includes an agentic AI-based on-premises tool 400 with a symbolic rules template 401, an extract agent 402, and a critic agent 403. An example of the symbolic rules template 401 is illustrated in FIG. 4B. Specific vulnerability information 301, such as in the form of a CVE or an SVE, is also illustrated in FIG. 4B. Extracting vulnerable components 303 also includes an API 410 and a security center 420 with a validator 421. Various ones of these components were described above.

As shown in FIG. 4B, the extract agent 402 derives symbolic rules, which are evaluated by the critic agent 403. The critic agent 403, such as via the API 410, checks the derived symbolic rules with the validator 421, which checks at least rule grammar and machine-acceptable components. Checking the machine-acceptable components may include generating chain-of-thought (CoT) reasoning tables of different combinations of multi-components in the executable symbolic rule expression. For instance, the validator 421 may provide a chain-of-thought reasoning table for “((OS, 12) AND (Smart Suggestions, to 4.1.01.0)” in the example of FIG. 4A. The rule grammar and machine-acceptable components checks, together with the generation of chain-of-thought reasoning tables, may individually or collectively serve to enforce guardrails on one or both of the extract agent 402 or the critic agent 403.

Based on those checks, the critic agent 403 provides feedback to the extract agent 402 for refinement of the symbolic rules. The LLM-based actor-critic self-correcting technique allows generation of accurate and concise executable symbolic rules expressions that are ready to be executed without waiting for human evaluation in the loop. FIG. 4C illustrates an example of the executable symbolic rules 304 that correspond to the specific vulnerability information 301 in FIG. 4B.

The actor-critic collaborative technique of this disclosure includes two LLM-based agents (the extract agent 402 and the critic agent 403) and a guardrail (the validator 421). The extract agent 402 extracts vulnerable components from the vulnerability report. The critic agent 403 calls the validator 421 as a tool, such as on cloud via a Representational State Transfer API (RESTful-API) or other interface, and summarizes results from the validator 421 as critic feedback. The critic feedback can be fed to the extract agent 402 without human interaction. The validator 421 conducts grammar checks and machine-acceptable component checks based on the symbolic rules passed by the critic agent 403. The validator 421 therefore functions as a guardrail to prevent LLMs from hallucinations due to the stochastic nature thereof. These components orchestrate together autonomously and give accurate and executable symbolic rules.

One task of the extract agent 402 can include extracting or otherwise generating executable symbolic rules 304 as output given a vulnerability report as input. Predefined LLM in-context learning executable symbolic rules templates 401 can be used to teach an LLM the correct grammar when generating executable symbolic rules 304. In some cases, the data source of vulnerability report (vulnerability information 301) can be a CVE list from the MITRE Corporation, the National Vulnerability Database (NVD) from the National Institute of Standards and Technology (NIST), a manufacturer's internal data source (such as a security maintenance release), or websites of vendor or product reports. The data source does not depend on the end-user.

A zero-shot extraction of executable symbolic rules from a new vulnerability report may not be accurate or executable in a security center backend, since the new vulnerability is not registered. To address this, the symbolic rules templates 401 can be provided, such as in a database. A symbolic rules templates database can store a variety of mapping examples, such as (for the example shown in FIG. 4B) in the form {input: vulnerability_report. json, output: executable_symbolic_rules. txt}. These examples are vulnerability-report-to-rules mappings covering multiple vendors of hardware components and software/firmware providers for mobile devices. By way of example, the symbolic rules templates database can help the extract agent 402 to accurately map a new 0-day vulnerability to affected components since (i) the symbolic rules templates database stores vulnerability-report-to-rules mapping of a known threat (CVE-2023-26072) and (ii) the extract agent 402 has prior knowledge from the symbolic rules templates database. For a new zero-day threat (CVE-2023-28613) sharing the same vendor and/or product with known vulnerability records, the extract agent 402 can accurately predict a vulnerability-to-component mapping.

The LLM-based critic agent 403 helps to ensure that generated executable symbolic rules are machine-actionable on the backend of the security center 420. For example, the critic agent 403 may interact with the validator 421 to pinpoint impairment between LLM-generated rules and machine-actionable versions. For instance, the critic agent 403 may call the validator 421 as a tool, such as on-cloud via a RESTful-API or other interface, and summarize results from the validator 421 as critic feedback fed to the extract agent 402 without human interaction. An example of a prompt that could be generated by the critic agent 403 is provided below.

```
def critic_node(self, state: MessagesState) ->
Command[Literal[“extractor”, END]]:
  # define the critic agent here
  critic_agent = create_react_agent(
      self.llm,
```

| | |
|---|---|
| tools=[my_helper.symbolic_rule_validator_api], | --> |

```
Call validator as a tool on-cloud via a RESTful-API
      # prompt=make_system_prompt (‘‘)
      prompt=f”““
        You are a critic. You are an expert in cybersecurity
        and you are familiar with CVE reports and related
        texts.
        You are very good at judging and make critics on
        whether the generated output from another expert
        complies with the rules.
        Now you will be given an output from another
        cybersecurity expert. You need to check its output
        based on the following formatting rules:
        ---- start of formatting rules ----
        {my_helper.get_affected_component_output_rules( )}
        ---- end of formatting rules ----
        Besides the rules above, you are also allowed to use
        the provided tools to determine whether the
        generated output is correct. You can use the tool
        ‘symbolic_rule_validator_api’ to validate the
        grammar of the output.
        If there is no violation of the rules, write out the
        component tuples and conjunction logic provided by
        the extractor with ‘### FINAL ANSWER BEGINS ###’ and
        ‘### FINAL ANSWER ENDS ###’ such as:
        ### FINAL ANSWER BEGINS ###.
```

| | |
|---|---|
| [... what the extractor provided with ...]. | --> |

```
        Summarize validator's results, if return True
        ### FINAL ANSWER ENDS ###
        If there is any violation of the rules, provide your
        feedback if you think any of the rules are violated.
        Then write:
        ### CRITIC FEEDBACK BEGINS ###
```

| | |
|---|---|
| ...your feedback here... | --> |

```
        Summarize validator's results, if return Exception
        error message
        ### CRITIC FEEDBACK ENDS ###
        Do not give a revised version.
        ...
    “““,
)
```

The validator 421, which may be hosted on-cloud in some cases, can check symbolic rules based on domain-specific language (DSL) standards, possibly from two perspectives (grammar and machine-acceptable components). For example, the validator 421 can verify if a received symbolic rule follows expected grammar, providing a customized error message for each exception while returning “true” or other positive indicator when parsing to the end of the generated executable symbolic rule with no exception being raised. As an example, consider the following example executable symbolic rule.
Component A OR Component B AND NOT Component C,
   Here, Component=(vendor/product name, model/version), and a domain-specific executable symbolic rule grammar validation can apply a simple state machine (parser) to validate the grammar of the generated executable symbolic rule. For instance, the domain-specific executable symbolic rule grammar validation may contain the following.

```
  check_parentheses(s)
  tokenize(s): ( | ) | key=value | key value | =value | key=
| AND | NOT | , |
  validate_tokens(tokens)
```

In validate_tokens(tokens), validation of tokens can use a state machine (parser), such as State_1-->token-->State_2. In some embodiments, six states may be supported, such as in the following manner.
START
OPEN_PAREN
PROPERTY: “key=value”
COMMA
CLOSE_PARENT
OPERATOR: AND|OR

For State=START, the state machine transitions may be defined as follows.

| | | | |
|---|---|---|---|
| START | --> | ( | --> OPEN_PAREN |
| START | --> | other token | --> Exception |

For State=OPEN_PAREN, the state machine transitions may be defined as follows.

| | | | | |
|---|---|---|---|---|
| OPEN_PAREN | --> | ( | --> | OPEN_PAREN |
| OPEN_PAREN | --> | key=value | --> | PROPERTY |
| OPEN_PAREN | --> | key value | --> | Exception |
| OPEN_PAREN | --> | =value | --> | Exception |
| OPEN_PAREN | --> | key= | --> | Exception |
| OPEN_PAREN | --> | other token | --> | Exception |

For State=PROPERTY, the state machine transitions may be defined as follows.

| | | | | |
|---|---|---|---|---|
| PROPERTY | --> | , | --> | COMMA |
| PROPERTY | --> | ) | --> | CLOSE_PAREN |
| PROPERTY | --> | other token | --> | Exception |

For State=COMMA, the state machine transitions may be defined as follows.

| | | | | |
|---|---|---|---|---|
| COMMA | --> | key=value | --> | PROPERTY |
| COMMA | --> | key value | --> | Exception |
| COMMA | --> | =value | --> | Exception |
| COMMA | --> | key= | --> | Exception |
| COMMA | --> | other token | --> | Exception |

For State=CLOSE_PAREN, the state machine transitions may be defined as follows.

| | | | | |
|---|---|---|---|---|
| CLOSE_PAREN | --> | AND \| OR | --> | OPERATOR |
| CLOSE_PAREN | --> | ) | --> | CLOSE_PAREN |
| CLOSE_PAREN | --> | ‘END’ | --> | Return |
| CLOSE_PAREN | --> | other token | --> | Exception |

For State=OPERATOR, the state machine transitions may be defined as follows.

| | | | | |
|---|---|---|---|---|
| OPERATOR | --> | ( | --> | OPEN_PAREN |
| OPERATOR | --> | other token | --> | Exception |

The backend server of the security center 420 can maintain up-to-date acceptable values from the device specifications database. Upon receiving an API call or other call from the critic server 403, the backend server of the security center 420 can validate machine-acceptable vulnerable components. For example, the API 410 may return an invalid key or a value for a chipsetVendor, osVersion, or chipsetModel and the associated allowed values list when the backend server receives executable symbolic rules 304. An example of an error message is “For ‘chipsetModel=Chip Q’, invalid field value: ‘Chip Q’. Allowed values are: ‘[‘Chip X’, ‘Chip Y’, ‘Chip Z’]’.” The analysis result can be sent back through the API 410 to the agentic AI-based on-premises tool 400. Thus, the critic agent 403 can leverage the agentic AI-based on-premises tool 400 to generate critic feedback for the extract agent 402 to create executable symbolic rules 304.

Referring back to FIG. 3B, after a vulnerability-to-components mapping in the form of one or more executable symbolic rules 304 is generated in extracting vulnerable components 303, the executable symbolic rule(s) 304 can be provided to the security center backend executor 305 for execution. During execution, the security center backend executor 305 can decode each executable symbolic rule 304 into one or more individual executable components following the grammar of the executable symbolic rule 304. The security center backend executor 305 can query a database of the device specifications 306, which can contain detailed device specifications (such as device project names, model code, SoC manufacturers, Wi-Fi chipsets, GPU kernel drivers/versions, user interface (UI) versions, OS versions, etc.). The security center backend executor 305 can match entries in the device specifications 306 to the names and values of device fields represented in each executable symbolic rule. This process yields the predicted analysis results 308, identifying potentially affected device models with matched affected hardware and software/firmware configurations. The predicted analysis results 308 can be reported (such as per device) to security center subscribers (customers). In some embodiments, no AI may need to be used to execute the executable symbolic rules 304, and the LLM-based extract agent 402 and critic agent 403 do not need to have access to the backend server of the security center 420. More specifically, AI agents do not need to have access to customer mobile device data.

Referring back to FIG. 3C, the LLM-based cyber security expert mitigation strategy generator 309 can produce one or more feature-level mitigation strategies. The feature-level mitigation strategies can integrate with an MDM solution to allow corporate IT administrators to remotely conduct the feature-level changes in a fleet-wide manner when patch updating is not available. Thus, corporate devices can be safe in use and may no longer be at risk of exploitation. In addition, cyber security expert knowledge from the LLM with cybersecurity role and system instruction prompts can be leveraged to feed vulnerability data, and a chain-of-thought analysis can be generated, which includes the steps and reasoning for each mitigation strategy classification.

In some embodiments, LLM prompt construction using vulnerability report information may include both internal and external vulnerability data sources. In some cases, prompts may include a vulnerability description, CVSS, affected product(s), affected vendor(s), problem type(s), reference solution link(s), and/or assigner to fix the corresponded vulnerability. Example recommended mitigation strategies for few-shot classification may include disabling NFC, disabling USB, disabling insecure Wi-Fi network, disabling Bluetooth, and unknown. The LLM-based cyber security expert mitigation strategy generator 309 may be employed to disable the vulnerable functionality of mobile devices. In this way, even if the affected devices are not able to apply software patches, unpatched corporate mobile devices can remain in use, and the risk of vulnerability exploitation can be mitigated.

Although FIGS. 4A through 4C illustrate examples of aspects of extracting vulnerable components 303 within the workflow 300 of FIGS. 3A through 3C, various changes may be made to FIGS. 4A through 4C. For example, the number of iterations by which the extract agent 402 and the critic agent 403 create executable symbolic rules may be limited. Also, the validator 421 may check rules grammar and machine-acceptable components in different iterations or generate chain-of-reasoning tables last after correcting rules grammar and machine-acceptable components.

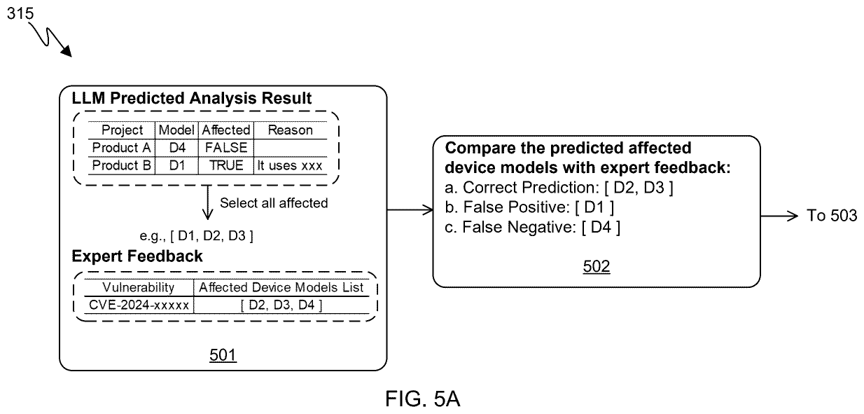

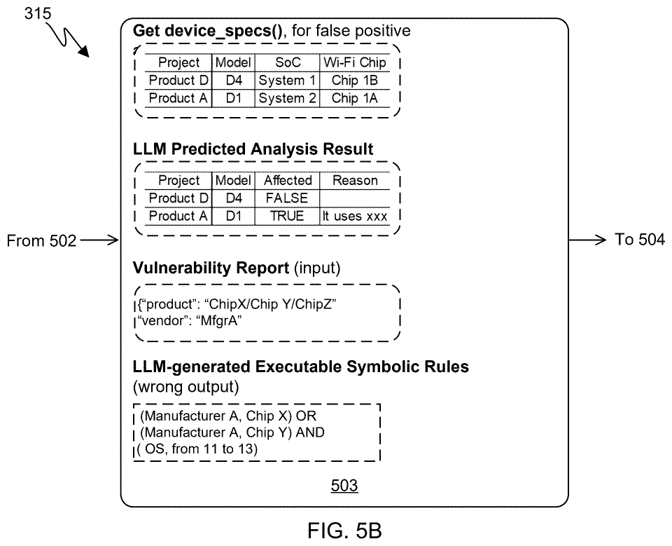

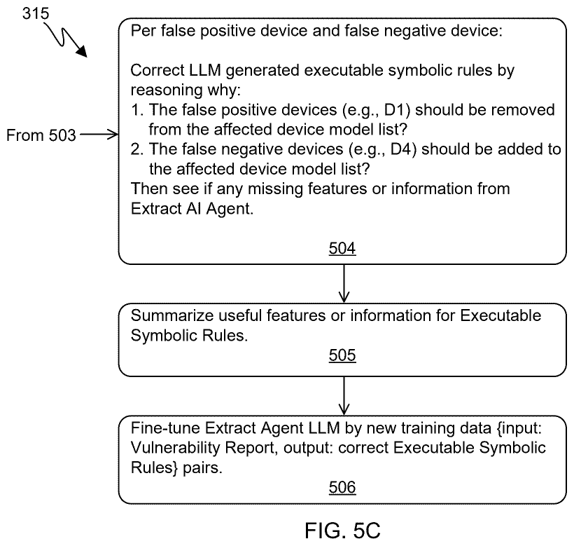

FIGS. 5A through 5C illustrate an example overview of adaptive expert feedback 315 within the workflow of FIGS. 3A through 3C in accordance with this disclosure. As noted with respect to FIG. 3A, the extract agent 402 (within the LLM symbolic rules generation agents 302) can improve accuracy over time based on expert feedback 315 via automatic LLM fine turning 310.

As shown in FIGS. 5A through 5C, at block 501, the LLM-predicted analysis results 308 are used to determine affected devices (such as devices D1, D2, and D3 in the example shown). The affected devices can also be identified from expert feedback 314 (such as devices D2, D3, and D4 in the example shown). In block 502, a comparison is made of the predicted affected device models with the expert feedback. In the example shown, this identifies correct predictions as devices D2 and D3, false positives as device D1, and false negatives as device D4.

In block 503, the device specifications 306 for the false positives, the LLM-predicted analysis results 308, the vulnerability information 301, and the LLM-generated executable symbolic rules 304 are reviewed. In block 504, for each false positive device and for each false negative device, corrections to the LLM-generated executable symbolic rules are generated. In some cases, the corrections can be made by reasoning why (i) the false positive devices (such as D1) should be removed from the affected device model list and (ii) the false negative devices (such as D4) should be added to the affected device model list. A determination is made whether there are any missing features or information from the extract agent 402. In block 505, useful features or information are summarized for correcting the executable symbolic rules. In block 506, fine-tuning of the extract agent 402 is performed with new training data. In some cases, the new training data may include {input: Vulnerability Report, output: Executable Symbolic Rules} pairs with corrected executable symbolic rules.

In some cases, expert feedback may be provided each time a vulnerability is patched per device. This expert feedback may be leveraged to manually create a correct mapping from a vulnerability report to executable symbolic rules 304, such as in the form {input: vulnerable report, output: correct Executable Symbolic Rules}. The correct mapping may be used as a ground truth, which can serve as part of a fine-turning dataset for the extract agent 402.

For each vulnerability previously reported, false positive affected device models (such as devices where LLM-predicted analysis results 308=“TRUE” and expert feedback 314=“FALSE”) and false negative affected device models (such as devices where LLM-predicted analysis results 308=FALSE and expert feedback 314=“FALSE”) can be identified by comparing the affected device models from the predicted analysis results 308 to the ground truths of the expert feedback 314 on the affected device models. For the false positive and false negative affected device models, device specifications data from the device specifications 306 may be identified, along with additional inputs for further review. The additional inputs may include one, some, or all of the following.
1. Predicted analysis results 308, leveraging 0-day LLM-based agents executed from the backend server of the security center 420, where the predicted analysis results 308 provide matched vendor/product names and associated values/versions in a reason column for affected device models;
2. The vulnerability report; and
3. The LLM-generated executable symbolic rules 304 (a sequence of the wrong symbolic rules) from 0-day.

In some cases, a human may review that information to find any missing features or information from the executable symbolic rules 304 generated by the extract agent 402, such as in order to find false positive affected device models. These false positives can be removed from an affected device model list. In a similar manner, false negative affected device models can be added to the affected device model list.

After this reasoning context is generated, useful features and reasoning information can be summarized, such as in symbolic rule pairs having the form {input: vulnerable report, output: correct Symbolic Rules}. Those pairs can be employed as the fine-turning dataset. Finally, LLM fine-tuning of the extract agent 403 can be performed to improve the accuracy of interim vulnerability assessments by aligning the extract agent 403 with expert domain knowledge preferences.

In other embodiments, the human evaluation in block 504 to correct false positive and false negative cases can extend to an LLM-based reasoning and action (ReAct) agent. For example, a ReAct agent can take action by calling one or more data source APIs (such as device specifications) and calling one or more public or other data source references (such as advisories, vendor solutions, product documentation, and tools). In addition, the ReAct agent can perform reasoning by leveraging one or more LLMs and inferring false positive and false negative cases. In some cases, such a ReAct agent may be employed in the agentic AI-driven cybersecurity framework. Since the ReAct Agent can reason on behalf of humans, this allows more of the process to be automated.

Also, in other embodiments, multiple LLMs using appropriate model sizes and providers may be adapted to fit the specific task of each agent. For example, because a public dataset may be input to extract vulnerable components 303, one or more cloud-based or other third-party LLMs may be used to perform NLP tasks for the extract agent 402 and another for the logical task of the critic agent 403.

The feedback agent described here leverages AI to generate actionable symbolic rules to identify and mitigate vulnerabilities across corporate mobile devices or other devices. Some specific applications in which this tool may be useful can include the following.

Zero-Day Vulnerability Response: When a zero-day vulnerability is disclosed, organizations often need to act quickly to assess which devices are at risk, even if patching is not immediately possible. The framework described above can rapidly identify affected devices fleet-wide, and AI feedback can be used to generate accurate and concise executable symbolic rules with a device specifications database. The executable symbolic rules are, in turn, safely executed on a non-AI backend. The framework generates mitigation recommendations on how to mitigate vulnerable devices without relying solely on patch availability. This helps to ensure device continuity while minimizing the attack surface during the vulnerability's exposure window.

Manage Un-Patchable Devices: Many organizations, such as in the healthcare, financial services, and transportation and logistics industries, operate custom applications that do not always support the latest operating systems. On these devices, customers are unable to install the latest security patches and are left with high numbers of device vulnerabilities. The agentic AI-powered cybersecurity framework allows IT teams to enforce compensating controls on fleet-wide affected mobile devices or other devices. This provides time for companies to update their applications to support the latest operating system versions while still attempting to maintain security compliance.

Rapid Incident Containment in Mobile-First Workforces: Mobile-first organizations face heightened risks from widespread vulnerabilities, especially when employees are geographically dispersed or rely heavily on mobile devices for operations. The framework described above automates the identification of impacted devices across geographies, carriers, and device types. The framework recommends device model-specific mitigation strategies that do not necessarily require software/firmware or hardware upgrades to prevent vulnerability exploitation while maintaining productivity.

Although FIGS. 5A through 5C illustrate one example of an overview of adaptive expert feedback 315 within the workflow of FIGS. 3A through 3C, various changes may be made to FIGS. 5A through 5C. For example, both human review and processing by a ReAct agent may be performed for the false positives, the false negatives, or both.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompasses such changes and modifications as fall within the scope of the appended claims.

What is claimed is:

1. A method comprising:
receiving a security vulnerability report from an external source describing a security vulnerability in a natural language;
generating at least one executable symbolic rule based on the security vulnerability report using predefined executable symbolic rules templates, the at least one executable symbolic rule generated using at least one large language model (LLM)-based executable symbolic rules agent trained to generate executable symbolic rules based on security vulnerability reports;
executing the at least one executable symbolic rule on a database of devices that includes specifications of the devices to provide analysis information on which of the devices are affected by the security vulnerability;
receiving the analysis information together with the report at an LLM-based recommender agent trained to recommend mitigation strategies;
recommending a mitigation strategy for the devices affected by the security vulnerability using the LLM-based recommender agent; and
providing the analysis information and the mitigation strategy to a web portal.

2. The method of claim 1, wherein generating the at least one executable symbolic rule comprises:
processing the report with the predefined executable symbolic rules templates using an LLM-based extract agent trained to infer initial executable symbolic rules from security vulnerability reports; and
evaluating the initial executable symbolic rules using an LLM-based critic agent trained to evaluate executable symbolic rules and obtain validation that the initial executable symbolic rules contain machine-acceptable components.

3. The method of claim 2, wherein:
the LLM-based critic agent provides feedback regarding the initial executable symbolic rules to the LLM-based extract agent; and
the LLM-based extract agent and the LLM-based critic agent iteratively improve the initial executable symbolic rules.

4. The method of claim 3, further comprising:
updating training of one or both of the LLM-based extract agent or the LLM-based critic agent based on expert feedback information from an external source.

5. The method of claim 3, wherein the LLM-based critic agent provides the feedback regarding the initial executable symbolic rules to the LLM-based extract agent based on:
grammar of the initial executable symbolic rules;
the validation that the initial executable symbolic rules contain machine-acceptable components; and
chain-of-thought reasoning tables of different combinations of multi-components in the initial executable symbolic rules.

6. The method of claim 1, wherein recommending the mitigation strategy comprises:
providing the LLM-based recommender agent with descriptive information for the security vulnerability, the descriptive information comprising at least one of: a Common Vulnerability Scoring System (CVSS) score, an identification of affected devices, an identification of affected vendors, a problem type, or a reference solution link; and
using the LLM-based recommender agent, generating feature-level mitigation strategies other than patches or operating system (OS) updates based on the analysis information and the descriptive information.

7. The method of claim 1, wherein the at least one executable symbolic rule comprises at least one logical operator.

8. A system comprising:
at least one communication interface; and
at least one processing device in communication with the at least one communication interface, wherein the at least one processing device is configured to:
receive a security vulnerability report from an external source describing a security vulnerability in a natural language via the at least one communication interface;
generate at least one executable symbolic rule based on the security vulnerability report using predefined executable symbolic rules templates, the at least one executable symbolic rule generated using at least one large language model (LLM)-based executable symbolic rules agent trained to generate executable symbolic rules based on security vulnerability reports;
execute the at least one executable symbolic rule on a database of devices that includes specifications of the devices to provide analysis information on which of the devices are affected by the security vulnerability;
receive the analysis information together with the report at an LLM-based recommender agent trained to recommend mitigation strategies;
recommend a mitigation strategy for the devices affected by the security vulnerability using the LLM-based recommender agent; and
provide the analysis information and the mitigation strategy to a web portal.

9. The system of claim 8, wherein, to generate the at least one executable symbolic rule, the at least one processing device is configured to:
process the report with the predefined executable symbolic rules templates using an LLM-based extract agent trained to infer initial executable symbolic rules from security vulnerability reports; and
evaluate the initial executable symbolic rules using an LLM-based critic agent trained to evaluate executable symbolic rules and obtain validation that the initial executable symbolic rules contain machine-acceptable components.

10. The system of claim 9, wherein:
the LLM-based critic agent is configured to provide feedback regarding the initial executable symbolic rules to the LLM-based extract agent; and
the LLM-based extract agent and the LLM-based critic agent are configured to iteratively improve the initial executable symbolic rules.

11. The system of claim 10, wherein the at least one processing device is further configured to update training of one or both of the LLM-based extract agent or the LLM-based critic agent based on expert feedback information from an external source.

12. The system of claim 10, wherein the LLM-based critic agent is configured to provide the feedback regarding the initial executable symbolic rules to the LLM-based extract agent based on:
grammar of the initial executable symbolic rules;
the validation that the initial executable symbolic rules contain machine-acceptable components; and
chain-of-thought reasoning tables of different combinations of multi-components in the initial executable symbolic rules.

13. The system of claim 8, wherein, to recommend the mitigation strategy, the at least one processing device is configured to:
provide the LLM-based recommender agent with descriptive information for the security vulnerability, the descriptive information comprising at least one of: a Common Vulnerability Scoring System (CVSS) score, an identification of affected devices, an identification of affected vendors, a problem type, or a reference solution link; and
generate feature-level mitigation strategies other than patches or operating system (OS) updates based on the analysis information and the descriptive information using the LLM-based recommender agent.

14. The system of claim 8, wherein the at least one executable symbolic rule includes at least one logical operator.

15. A non-transitory machine readable medium containing instructions that when executed cause at least one processor of an electronic device to:
receive a security vulnerability report from an external source describing a security vulnerability in a natural language;
generate at least one executable symbolic rule based on the security vulnerability report using predefined executable symbolic rules templates, the at least one executable symbolic rule generated using at least one large language model (LLM)-based executable symbolic rules agent trained to generate executable symbolic rules based on security vulnerability reports;
execute the at least one executable symbolic rule on a database of devices that includes specifications of the devices to provide analysis information on which of the devices are affected by the security vulnerability;
receive the analysis information together with the report at an LLM-based recommender agent trained to recommend mitigation strategies;
recommend a mitigation strategy for the devices affected by the security vulnerability using the LLM-based recommender agent; and
provide the analysis information and the mitigation strategy to a web portal.

16. The non-transitory machine readable medium of claim 15, wherein the instructions that when executed cause the at least one processor to generate the at least one executable symbolic rule comprise instructions that when executed cause the at least one processor to:
process the report with the predefined executable symbolic rules templates using an LLM-based extract agent trained to infer initial executable symbolic rules from security vulnerability reports; and
evaluate the initial executable symbolic rules using an LLM-based critic agent trained to evaluate executable symbolic rules and obtain validation that the initial executable symbolic rules contain machine-acceptable components.

17. The non-transitory machine readable medium of claim 16, wherein:
the LLM-based critic agent is configured to provide feedback regarding the initial executable symbolic rules to the LLM-based extract agent; and
the LLM-based extract agent and the LLM-based critic agent are configured to iteratively improve the initial executable symbolic rules.

18. The non-transitory machine readable medium of claim 17, further containing instructions that when executed cause the at least one processor to update training of one or both of the LLM-based extract agent or the LLM-based critic agent based on expert feedback information from an external source.

19. The non-transitory machine readable medium of claim 17, wherein the LLM-based critic agent is configured to provide the feedback regarding the initial executable symbolic rules to the LLM-based extract agent based on:
grammar of the initial executable symbolic rules;
the validation that the initial executable symbolic rules contain machine-acceptable components; and
chain-of-thought reasoning tables of different combinations of multi-components in the initial executable symbolic rules.

20. The non-transitory machine readable medium of claim 15, wherein the instructions that when executed cause the at least one processor to recommend the mitigation strategy comprise instructions that when executed cause the at least one processor to:
provide the LLM-based recommender agent with descriptive information for the security vulnerability, the descriptive information comprising at least one of: a Common Vulnerability Scoring System (CVSS) score, an identification of affected devices, an identification of affected vendors, a problem type, or a reference solution link; and
generate feature-level mitigation strategies other than patches or operating system (OS) updates based on the analysis information and the descriptive information using the LLM-based recommender agent.
